(19) United States
(12) Patent Application Publication
(10) Pub. No.: US 2026/0340836 A1
(43) Pub. Date: Oct. 29, 2026

(54) IMAGE PROCESSING APPARATUS, METHOD AND PROGRAM FOR EXTRACTING REGION OF MEDICAL IMAGE BY NEURAL NETWORK

(71) Applicant: FUJIFILM Corporation, Tokyo (JP)

(72) Inventor: Satoshi IHARA, Tokyo (JP)

(73) Assignee: FUJIFILM Corporation, Tokyo (JP)

(21) Appl. No.: 19/732,517

(22) Filed: Jul. 6, 2026

Related U.S. Application Data
(63) Continuation of application No. 18/327,027, filed on May 31, 2023, now Pat. No. 12,705,749.
Application No. 18/327,027 is a continuation of application No. PCT/JP2021/042482, filed on Nov. 18, 2021.

(30) Foreign Application Priority Data
Jan. 18, 2021 (JP) 2021-005804

(51) Int. Cl. G06T 7/11; G06T 3/40; G06T 7/00

(52) U.S. Cl. CPC G06T 7/11; G06T 3/40; G06T 7/0012; G06T 2207/20084; G06T 2207/30056

(57) ABSTRACT

An image processing apparatus which includes a processor which is configured to acquire a target image, reduce the target image to derive a reduced image of the target image, extract a first region from the reduced image to derive a reduced structure image including the first region by a first extraction model without rest of structures of the reduced image, enlarge the reduced structure image to have a same resolution as the target image to derive an enlarged reduced structure image, extracting, from the target image, a corresponding image which correlates to the enlarged reduced structure image, and deriving an extracted image by inputting at least one of the corresponding image or the enlarged structure image into a second extraction model constructed by machine-learning.

### CROSS-REFERENCE TO RELATED APPLICATIONS

The present application is a Continuation Application of and claims the priority benefit of a prior U.S. Application No. 18/327,027, filed on May 31, 2023, now allowed. The prior U.S. Application No. 18/327,027 is a Continuation of PCT International Application No. PCT/JP2021/042482, filed on Nov. 18, 2021, which claims priority to Japanese Patent Application No. 2021-005804, filed on Jan. 18, 2021. Each application above is hereby expressly incorporated by reference, in its entirety, into the present application.

### BACKGROUND

### TECHNICAL FIELD

The present disclosure relates to an image processing apparatus, method, and program for extracting a region of a medical image by utilizing a neural network.

### Related Art

In recent years, a machine learning technology using deep learning has attracted attention. In particular, various models have been proposed for segmenting an object included in an image by learning a convolutional neural network (hereinafter referred to as a CNN), which is one of multilayer neural networks in which a plurality of processing layers are hierarchically connected, by deep learning. In addition, a method for classifying the segmented regions has also been proposed. For example, JP2019-021313A proposes a method in which an input image is normalized, a given region is extracted from the normalized image, and the extracted region is applied to the input image to classify objects in the given region in the input image.

However, the method described in JP2019-021313A cannot extract an object included in an input image at high speed and with high accuracy.

### SUMMARY OF THE INVENTION

The present disclosure has been made in view of the above circumstances, and an object of the present disclosure is to enable high-speed and accurate extraction of an object included in an image.

According to an aspect of the present disclosure, there is provided an image processing apparatus comprising at least one processor, in which the processor is configured to: acquire a target image (G0); reduce the target image (G0) to derive a reduced image (GS0) of the target image (G0), extract a first region (e.g. liver) from the reduced image (GS0) to derive a reduced structure image (GS1) including the first region by a first extraction model (23A) without rest of structures of the reduced image, enlarge the reduced structure image (GS1) to have a same resolution as the target image (G0) to derive an enlarged reduced structure image (GS2), extract, from the target image (G0), a corresponding image (G1) which correlates to the enlarged reduced structure image (GS2), input at least one of the corresponding image (G1) or the enlarged reduced structure image (GS2) into an input layer (30) of a second extraction model (25A) which includes a plurality of processing layers (31-35) and is a neural network constructed by machine-learning to generate an output (F1) of the input layer (30); perform, by the plurality of processing layers (31-35), a convolution processing of the output (F1) of the input player (30) to generate an input (F6) to an output layer (36) of the neural network; and output, from the output layer (36), an extracted image (G2) in which a second region (e.g. liver in G2) is included, wherein the second region of the extracted image corresponds to the first region (e.g. liver in GS1).

In the image processing apparatus according to an embodiment of the present disclosure, the processor is further configured to enlarge the reduced structure image (GS1) to have a same size as the corresponding image (G1) to derive the enlarged reduced structure image (GS2).

In the image processing apparatus according to another embodiment of the present disclosure, the second extraction model further includes an output layer 36 which receives an output (F6) from the plurality of processing layers (31-36) to generate the extracted image (G2).

In the image processing apparatus according to another embodiment of the present disclosure, the processor may be configured to: divide the first region (e.g. liver) of the reduced image (GS0) into a plurality of regions so as to derive a first reduced structure image (GS11) and a second reduced structure image (GS12); derive a first corresponding image (G11) corresponding to the first reduced structure image (GS11) and as second corresponding image (G12) corresponding to the second reduced structure image (GS12); and extract a region corresponding to the first corresponding image (G11) and another region corresponding to the second corresponding image (G12).

In the image processing apparatus according to another embodiment of the present disclosure, the second extraction model (25A) is the neural network constructed by machine-learning by training with supervised training data (40) which includes a teacher-reduced liver image (41), a teacher-corresponding image (42), and a correct answer data (43).

In the image processing apparatus according to another embodiment of the present disclosure, the teacher-reduced liver image (41) is generated by extracting a target region from a reduced image of a medical image, and the teacher-corresponding image (42) is obtained from extracting a region of the teacher-reduced liver image (41) and from the correct answer data. Also, the correct answer data is an image in which the target region is masked in the teacher-corresponding image (42). the input layer (30) of a second extraction model (25A) has two channels (30A 30B) for inputting the corresponding image (G1) and the enlarged reduced structure image (GS2) respectively. Alternatively, the input layer (30) of a second extraction model (25A) has only one channel as one of the corresponding image (G1) or the enlarged reduced structure image (GS2) into the input layer (30) and other one is input into a layer of the plurality of processing layers.

According to another embodiment of the present disclosure, the disclosure provides an image processing method implemented by an image processing apparatus, and the method may include acquiring a target image (G0); reducing the target image (G0) to derive a reduced image (GS0) of the target image (G0); extracting a first region (e.g. liver) from the reduced image (GS0) to derive a reduced structure image (GS1) including the first region by a first extraction model (23A) without rest of structures of the reduced image; enlarging the reduced structure image (GS1) to have a same resolution as the target image (G0) to derive an enlarged reduced structure image (GS2); extracting, from the target image (G0), a corresponding image (G1) which correlates to the enlarged reduced structure image (GS2); inputting at least one of the corresponding image (G1) or the enlarged reduced structure image (GS2) into an input layer (30) of a second extraction model (25A) which includes a plurality of processing layers (31-35) and is a neural network constructed by machine-learning to generate an output (F1) of the input layer (30); performing, by the plurality of processing layers (31-35), a convolution processing of the output (F1) of the input player (30) to generate an input (F6) to an output layer (36) of the neural network; and outputting, from the output layer (36), an extracted image (G2) in which a second region (e.g. liver in G2) is included, wherein the second region of the extracted image corresponds to the first region (e.g. liver in GS1).

According to another embodiment of the present disclosure, the disclosure provides A non-transitory storage medium storing a computer executable program to configure a processor of an image processing apparatus to implement functions including: acquiring a target image (G0); reducing the target image (G0) to derive a reduced image (GS0) of the target image (G0); extracting a first region (e.g. liver) from the reduced image (GS0) to derive a reduced structure image (GS1) including the first region by a first extraction model (23A) without rest of structures of the reduced image; enlarging the reduced structure image (GS1) to have a same resolution as the target image (G0) to derive an enlarged reduced structure image (GS2); extracting, from the target image (G0), a corresponding image (G1) which correlates to the enlarged reduced structure image (GS2); inputting at least one of the corresponding image (G1) or the enlarged reduced structure image (GS2) into an input layer (30) of a second extraction model (25A) which includes a plurality of processing layers (31-35) and is a neural network constructed by machine-learning to generate an output (F1) of the input layer (30); performing, by the plurality of processing layers (31-35), a convolution processing of the output (F1) of the input player (30) to generate an input (F6) to an output layer (36) of the neural network; and outputting, from the output layer (36), an extracted image (G2) in which a second region (e.g. liver in G2) is included, wherein the second region of the extracted image corresponds to the first region (e.g. liver in GS1).

According to the aspects of the present disclosure, an object included in an image can be extracted at high speed and with high accuracy.

### BRIEF DESCRIPTION OF THE DRAWINGS

FIG. 1 is a diagram showing a schematic configuration of a diagnosis support system to which an image processing apparatus and a learning apparatus according to an embodiment of the present disclosure are applied.

FIG. 2 is a diagram showing a schematic configuration of the image processing apparatus and the learning apparatus according to the present embodiment.

FIG. 3 is a functional configuration diagram of the image processing apparatus and the learning apparatus according to the present embodiment.

FIG. 4 is a diagram schematically showing a process performed in the present embodiment.

FIG. 5 is a diagram schematically showing a configuration of an extraction model.

FIG. 6 is a diagram showing supervised training data used for learning.

FIG. 7 is a diagram schematically showing another configuration of the extraction model.

FIG. 8 is a diagram showing a display screen of a target image.

FIG. 9 is a flowchart showing learning processing performed in the present embodiment.

FIG. 10 is a flowchart showing image processing performed in the present embodiment.

FIG. 11 is a diagram for describing a receptive field for a liver region.

FIG. 12 is a diagram for describing a receptive field for a liver region.

FIG. 13 is a diagram for describing division of a liver region.

### DETAILED DESCRIPTION

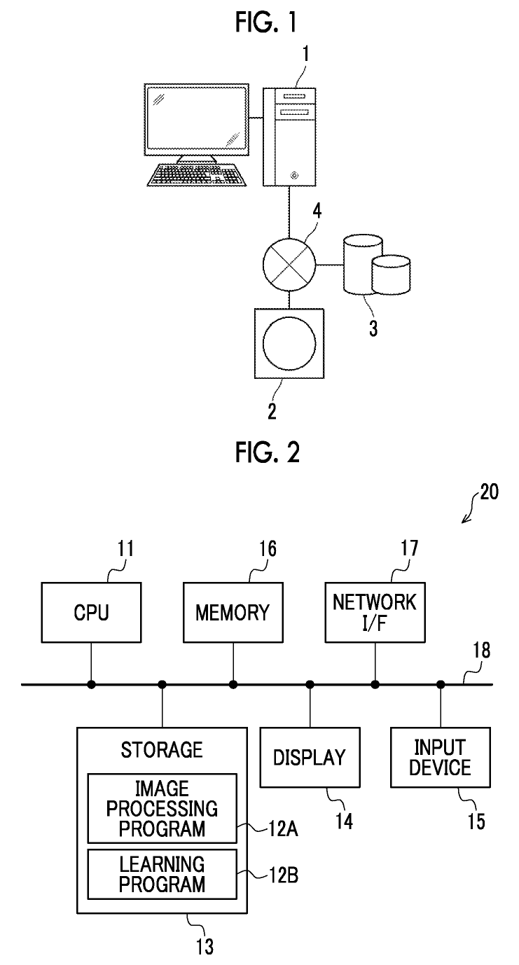

Hereinafter, an embodiment of the present disclosure will be described with reference to the drawings. First, a configuration of a medical information system to which an image processing apparatus and a learning apparatus according to the present embodiment are applied will be described. FIG. 1 is a diagram showing a schematic configuration of the medical information system. In the medical information system shown in FIG. 1, a computer 1 encompassing an image processing apparatus and a learning apparatus according to the present embodiment, an imaging apparatus 2, and an image storage server 3 are connected via a network 4 in a communicable state.

The computer 1 encompasses an image processing apparatus and the learning apparatus according to the present embodiment, and an image processing program and a learning program according to the present embodiment are installed in the computer 1. The computer 1 may be a workstation or a personal computer directly operated by a doctor performing diagnosis, or may be a server computer connected to a workstation and to a personal computer via a network. The image processing program and the learning program are stored in a storage apparatus of a server computer connected to the network or in a network storage in a state in which the network storage can be accessed from the outside, and are downloaded to and installed on the computer 1 used by a doctor in response to a request. Alternatively, the image processing program is recorded on a recording medium, such as a digital versatile disc (DVD) or a compact disc read only memory (CD-ROM), and distributed, and is installed on the computer 1 from the recording medium.

The imaging apparatus 2 is an apparatus that generates a three-dimensional image representing diagnosis target parts of a subject by imaging the part, and the imaging apparatus 2 is, specifically, a computed tomography (CT) apparatus, a magnetic resonance imaging (MRI) apparatus, a positron emission tomography (PET) apparatus, or the like. A three-dimensional image consisting of a plurality of slice images generated by the imaging apparatus 2 is transmitted to and saved in the image storage server 3. In the present embodiment, the imaging apparatus 2 is a CT apparatus, and a CT image of the thoracoabdominal region of a subject is generated as a three-dimensional image.

The image storage server 3 is a computer that saves and manages various types of data, and includes a large-capacity external storage apparatus and database management software. The image storage server 3 communicates with another apparatus via the wired or wireless network 4, and transmits/receives image data or the like. Specifically, various types of data including image data of a three-dimensional image generated by the imaging apparatus 2 are acquired via a network and saved in a recording medium such as a large-capacity external storage apparatus and managed. The storage format of the image data and the communication between the respective apparatuses via the network 4 are based on a protocol such as digital imaging and communication in medicine (DICOM). In addition, the image storage server 3 stores supervised training data, which will be described later.

Next, the image processing apparatus and the learning apparatus according to the present embodiment will be described. FIG. 2 illustrates the hardware configuration of the image processing apparatus and the learning apparatus according to the present embodiment. As shown in FIG. 2, the image processing apparatus and the learning apparatus (hereinafter sometimes represented by the image processing apparatus) 20 includes a central processing unit (CPU) 11, a non-volatile storage 13, and a memory 16 as a temporary storage area. Further, the image processing apparatus 20 includes a display 14 such as a liquid crystal display, an input device 15 such as a keyboard and a mouse, and a network interface (I/F) 17 connected to the network 4. The CPU 11, the storage 13, the display 14, the input device 15, the memory 16, and the network I/F 17 are connected to a bus 18. The CPU 11 is an example of a processor in the present disclosure.

The storage 13 is realized by a hard disk drive (HDD), a solid state drive (SSD), a flash memory, and the like. An image processing program 12A and a learning program 12B are stored in the storage 13 as a storage medium. The CPU 11 reads out the image processing program 12A and the learning program 12B from the storage 13, then loads the read-out programs into the memory 16, and executes the loaded image processing program 12A and learning program 12B.

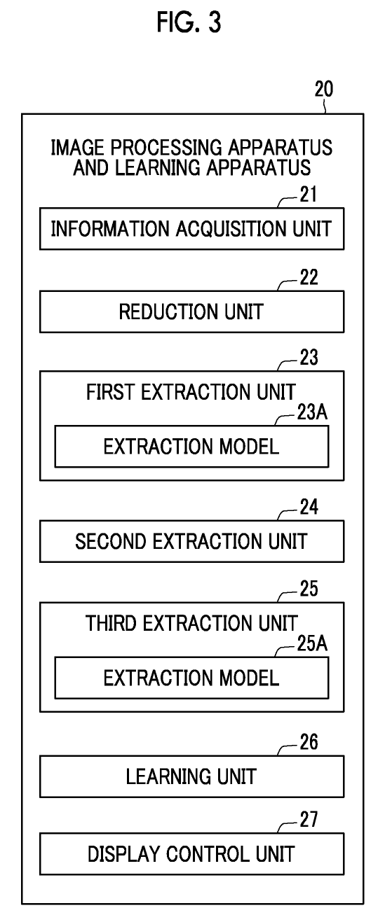

Next, a functional configuration of the image processing apparatus and the learning apparatus according to the present embodiment will be described. FIG. 3 is a diagram showing a functional configuration of the image processing apparatus and the learning apparatus according to the present embodiment. As shown in FIG. 3, the image processing apparatus 20 comprises an information acquisition unit 21, a reduction unit 22, a first extraction unit 23, a second extraction unit 24, a third extraction unit 25, a learning unit 26, and a display control unit 27. Then, the CPU 11 executes the image processing program 12A, so that the CPU 11 functions as the information acquisition unit 21, the reduction unit 22, the first extraction unit 23, the second extraction unit 24, the third extraction unit 25, and the display control unit 27. In addition, the CPU 11 executes the learning program 12B, so that the CPU 11 functions as the learning unit 26. In the present embodiment, it is assumed that a target image G0 is a CT image including the thoracoabdominal region of a human body, and a region of the liver is extracted from the target image G0 as a target structure.

The information acquisition unit 21 acquires a target image G0 to be processed from the image storage server 3 in response to an instruction from the input device 15 provided by an operator. In addition, the information acquisition unit 21 acquires supervised training data from the image storage server 3 for training an extraction model, which will be described later.

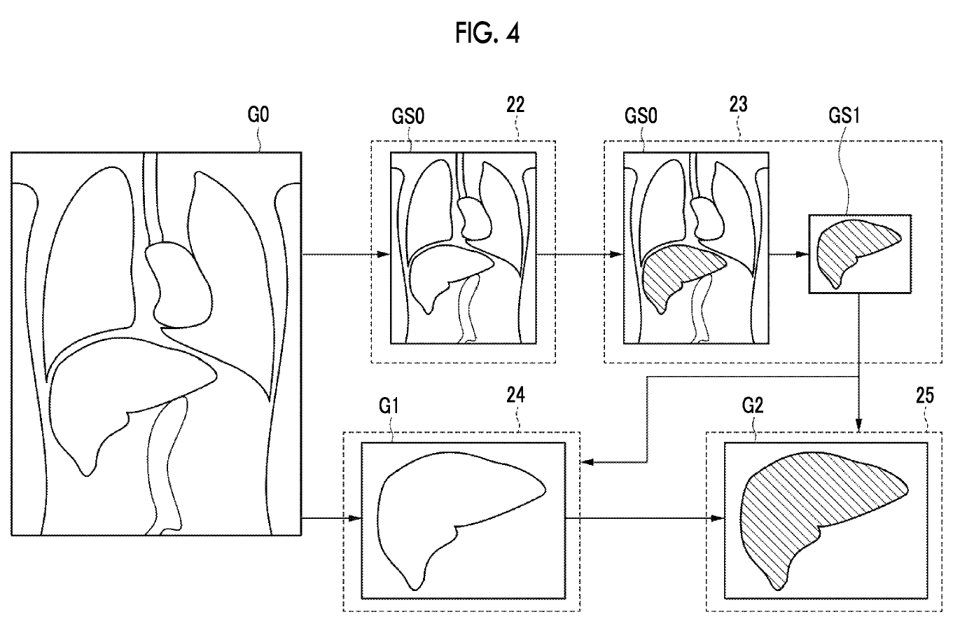

Hereinafter, a process performed by the reduction unit 22, the first extraction unit 23, the second extraction unit 24, and the third extraction unit 25 will be described with reference to FIG. 4.

The reduction unit 22 reduces the target image G0 to derive a reduced image GS0. A reduction rate can be set to, for example, 1/4, but the reduction rate is not limited thereto. For example, the reduction rate can be set to 1/2 to 1/16.

The first extraction unit 23 extracts a liver region as a region of the target structure from the reduced image GS0. In the present embodiment, the first extraction unit 23 extracts the liver region from the reduced image GS0 using an extraction model 23A constructed by machine-learning the neural network. The extraction model 23A consists of a neural network that has undergone machine learning such that a liver region is extracted from a CT image in a case where the CT image including the thoracoabdominal region of the human body is input. Note that, in FIG. 4, in the reduced image GS0, hatching is applied to the extracted liver region.

As methods for extracting the liver region from the reduced image GS0, in addition to the method using the extraction model 23A, threshold processing based on voxel values of the target image G0, a region growing method based on seed points representing the liver region, a template matching method based on the shape of the liver, a graph cut method, and the like can be used.

Then, the first extraction unit 23 derives a reduced liver image GS1 by clipping a rectangular region including the liver region in the reduced image GS0.

The second extraction unit 24 extracts a region corresponding to the reduced liver image GS1 from the target image G0 as a corresponding image. Specifically, the second extraction unit 24 enlarges the reduced liver image GS1 to have the same resolution as the target image G0, and extracts, as a corresponding image G1, a region in the target image G0 that has the greatest correlation with the enlarged reduced liver image GS1.

The third extraction unit 25 extracts a liver region included in the corresponding image G1. To this end, the third extraction unit 25 has an extraction model 25A constructed by machine-learning a neural network such that the liver region included in the corresponding image G1 is extracted in a case where the corresponding image G1 and the reduced liver image GS1 are input.

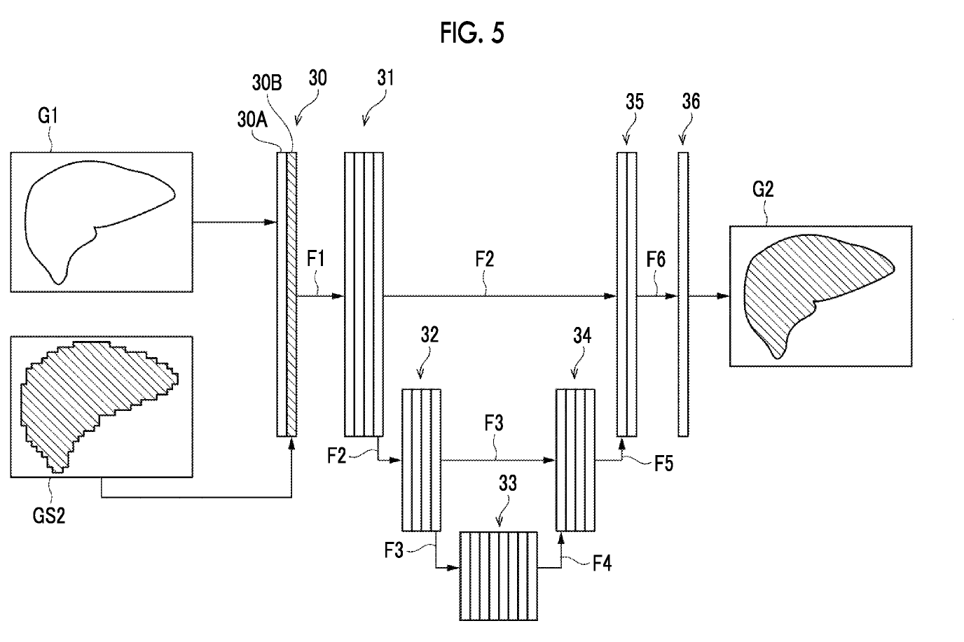

FIG. 5 is a diagram schematically showing a configuration of the extraction model 25A. As shown in FIG. 5, in the present embodiment, the extraction model 25A included in the third extraction unit 25 is configured by U-Net, which is a kind of convolutional neural network (CNN). The U-Net shown in FIG. 5 is composed of seven layers of an input layer 30, a first layer 31 to a fifth layer 35, and an output layer 36.

In the present embodiment, the third extraction unit 25 derives a reduced liver image GS2 in which the reduced liver image GS1 is enlarged to the same resolution as the corresponding image G1. Then, the third extraction unit 25 inputs the corresponding image G1 and the enlarged reduced liver image GS2 into the extraction model 25A. To this end, the input layer 30 has a channel 30A to which the corresponding image G1 is input and a channel 30B to which the reduced liver image GS2 is input. Note that, as the enlarged reduced liver image GS2, an enlarged reduced liver image derived by the second extraction unit 24 in the case of extracting the corresponding image G1 may be used.

The input layer 30 concatenates , that is, combines and convolves the corresponding image G1 and the enlarged reduced liver image GS2 with a predetermined kernel, and outputs a feature map F1 in which the corresponding image G1 and the enlarged reduced liver image GS2 are integrated. The feature map F1 is input to the first layer 31. In the present embodiment, for example, a 3 × 3 kernel is used for the convolution, but the convolution is not limited thereto.

The first layer 31 has, for example, four convolutional layers. A feature map F2 output from the first layer 31 is input to the fifth layer 35. Also, the feature map F2 is pooled, its size is reduced to 1/2, and the feature map F2 is input to the second layer 32. In the pooling, the maximum value among the four pixels is employed, but the present disclosure is not limited thereto.

The second layer 32 has, for example, four convolutional layers. A feature map F3 output from the second layer 32 is input to the fourth layer 34. Also, the feature map F3 is pooled, its size is reduced to 1/2, and the feature map F3 is input to the third layer 33.

The third layer 33 has, for example, eight convolutional layers. The feature map F4 output from the third layer 33 is upsampled, its size is doubled, and the feature map F4 is input to the fourth layer 34.

The fourth layer 34 has, for example, four convolutional layers, and performs the convolution operation by integrating the feature map F3 from the second layer 32 and the upsampled feature map F4 from the third layer 33. A feature map F5 output from the fourth layer 34 is upsampled, its size is doubled, and the feature map F5 is input to the fifth layer 35.

The fifth layer 35 has, for example, two convolutional layers, and performs the convolution operation by integrating the feature map F2 from the first layer 31 and the upsampled feature map F5 from the fourth layer 34. A feature map F6 output from the fifth layer 35 is input to the output layer 36.

The output layer 36 outputs an extracted image G2 obtained by extracting the liver region from the corresponding image G1.

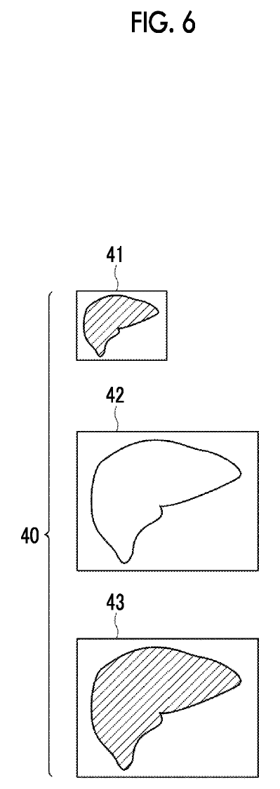

The extraction model 25A is constructed by machine-learning a neural network using a large amount of supervised training data. The learning unit 26 performs learning of the neural network. FIG. 6 is a diagram showing an example of supervised training data used for learning. As shown in FIG. 6, supervised training data 40 consists of a teacher-reduced liver image 41 generated by extracting the liver from a reduced image obtained by reducing a medical image, a teacher-corresponding image 42 obtained by extracting a region corresponding to the teacher-reduced liver image 41 in the medical image, and correct answer data 43. The teacher-reduced liver image 41 is an image in which the liver region is masked in the reduced image. The correct answer data 43 is an image in which the liver region is masked in the teacher-corresponding image 42. The teacher-reduced liver image 41 and the correct answer data 43 are generated by extracting a region of the liver while a user views the image. Note that the teacher-reduced liver image 41 is an example of a first image, and the teacher-corresponding image 42 is an example of a second image.

The learning unit 26 inputs the teacher-reduced liver image 41 and the teacher-corresponding image 42 to the neural network, and causes the neural network to extract the liver region in the teacher-corresponding image 42. Then, the learning unit 26 derives a difference between an extraction result by the neural network and the correct answer data 43 as a loss, and learns the connection weights and kernel coefficients of the neural network such that the loss is equal to or less than a predetermined threshold value.

Then, the learning unit 26 repeatedly performs learning until the loss becomes equal to or less than a predetermined threshold value. Accordingly, in a case where the reduced liver image GS1 and the corresponding image G1 are input, the extraction model 25A for extracting the liver region included in the corresponding image G1 is constructed. Note that the learning unit 26 may repeatedly perform learning a predetermined number of times.

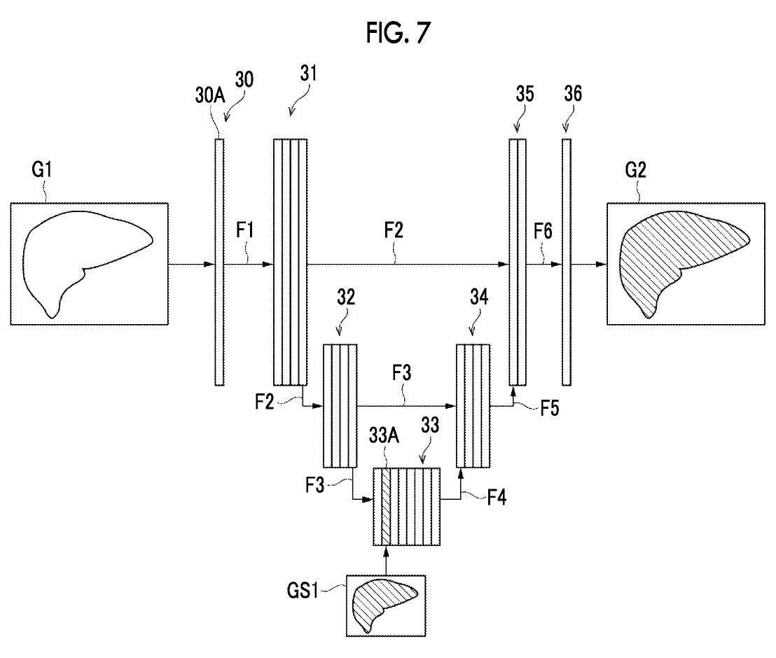

Note that the configuration of the U-Net constituting the extraction model 25A is not limited to that shown in FIG. 6. For example, as shown in FIG. 7, the input layer 30 may be composed of only one channel 30A for input of the corresponding image G1 and a channel 33A for inputting the reduced liver image GS1 may be added to the third layer 33 in which processing is performed on the feature map F3 having the same size as the reduced liver image GS1. In this case, the third layer 33 combines and convolves the feature map F3 and the reduced liver image GS1 input to the channel 33A, and outputs the feature map F4 in which the feature map F3 and the reduced liver image GS1 are integrated.

The display control unit 27 displays the target image G0 from which the liver region has been extracted on the display 14. FIG. 8 is a diagram showing a display screen of the target image. As shown in FIG. 8, a display screen 50 displays the target image G0. Further, a mask 60 based on the extracted image G2 is attached to the liver region of the displayed target image G0.

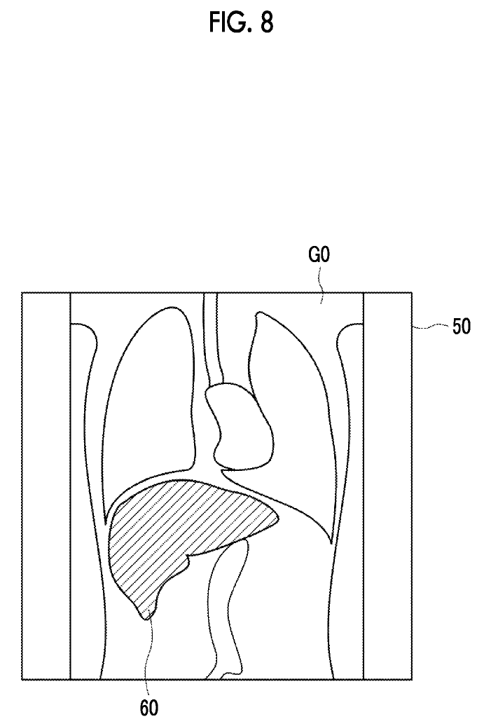

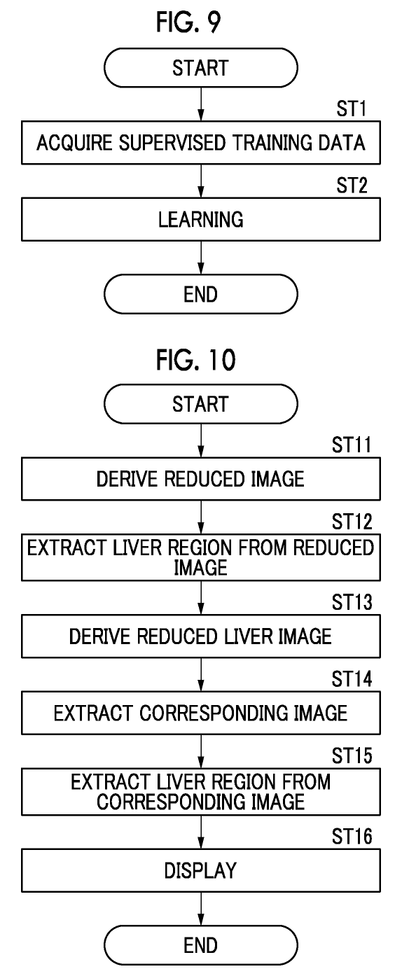

Next, a process performed in the present embodiment will be described. FIG. 9 is a flowchart showing learning processing performed in the present embodiment. It is assumed that the supervised training data is acquired from the image storage server 3 and is saved in the storage 13. The learning unit 26 acquires the supervised training data saved in the storage 13 (Step ST1), and uses the supervised training data to perform U-Net learning (Step ST2). Thereby, the extraction model 25A is constructed.

FIG. 10 is a flowchart showing image processing performed in the present embodiment. It is assumed that the target image G0 is acquired from the image storage server 3 and is saved in the storage 13. First, the reduction unit 22 reduces the target image G0 to derive the reduced image GS0 (Step ST11). Next, the first extraction unit 23 extracts a liver region from the reduced image GS0 (Step ST12), and derives the reduced liver image GS1 by clipping the rectangular region including the liver region in the reduced image GS0 (Step ST13).

Subsequently, the second extraction unit 24 extracts a region corresponding to the reduced liver image GS1 from the target image G0 as the corresponding image G1 (Step ST14). Then, the third extraction unit 25 extracts the liver region from the corresponding image G1 (Step ST15). Further, the display control unit 27 displays the target image G0 from which the liver region has been extracted on the display 14 (Step ST16), and the process ends.

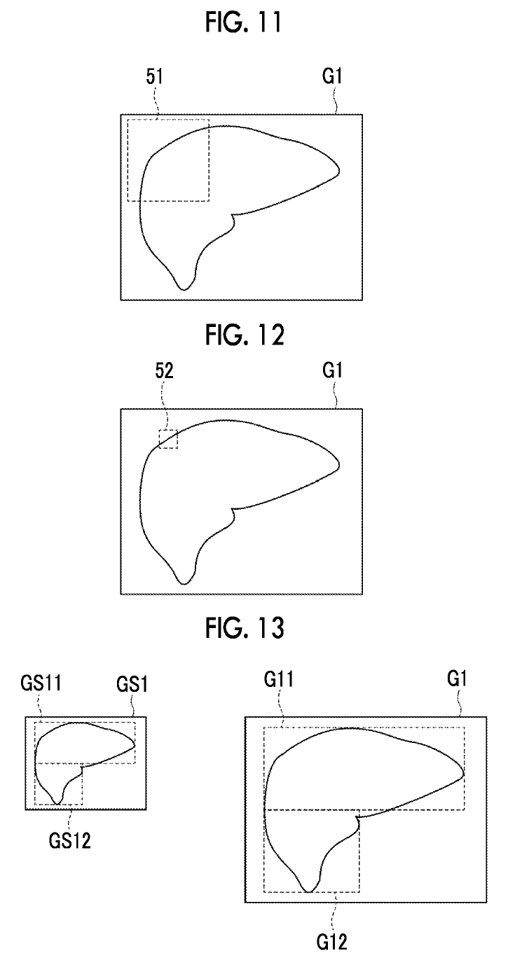

Here, extracting the liver region from the corresponding image G1 in a state where no information is given about the liver region is considered. In this case, as shown in FIG. 11, it is necessary to make the hierarchy of the neural network that constitutes the extraction model 25A deep (that is, to increase the number of layers) such that a large receptive field 51 capable of extracting features from the inside to the outside of the liver region as well as the boundary of the liver region can be obtained.

However, in a case where the hierarchy of the neural network is deepened, the processing time for learning and extraction becomes long, and thus a large amount of memory for processing is required. In addition, more supervised training data is required for learning.

In addition, in a case where an attempt is made to extract a liver region from a part region of the human body as in the corresponding image G1, information around the liver region is largely missing. For this reason, learning is difficult with a normal neural network, and there is a likelihood that the liver region cannot be extracted with high accuracy.

In the present embodiment, the corresponding image G1 and the reduced liver image GS1 are input to the extraction model 25A to extract the liver region included in the corresponding image G1. Here, a rough extraction result of the liver region included in the corresponding image G1 is known from the reduced liver image GS1. For this reason, it is only necessary to train the extraction model 25A such that only the boundary portion between the liver and the other region included in the corresponding image G1 can be discriminated. That is, as shown in FIG. 12, it is only necessary to obtain a small receptive field 52 enough to extract features around the boundary between the liver region and the other region. For this reason, it is possible to reduce the number of layers of the neural network that constitutes the extraction model 25A, and thus a large amount of memory for processing is not required. Therefore, it is possible to extract the liver region from the corresponding image G1 at high speed and with high accuracy.

In addition, in the above embodiment, the first extraction unit 23 may divide the extracted liver region and derive a divided and reduced liver image including each of the divided liver regions. FIG. 13 is a diagram for describing the division of the liver region. As shown in FIG. 13, the first extraction unit 23 divides the liver region extracted from the reduced image GS0 into an upper region and a lower region, and derives a first reduced liver image GS11 and a second reduced liver image GS12. In this case, the second extraction unit 24 extracts a first corresponding image G11 corresponding to the first reduced liver image GS11 and a second corresponding image G12 corresponding to the second reduced liver image GS12 from the target image G0. The first reduced liver image GS11 and the second reduced liver image GS12 are examples of divided and reduced structure images, and the first corresponding image G11 and the second corresponding image G12 are examples of divided corresponding images.

Further, the third extraction unit 25 inputs the first reduced liver image GS11 and the first corresponding image G11 into the extraction model 25A, and extracts an upper liver region from the first corresponding image G11. Further, the third extraction unit 25 inputs the second reduced liver image GS12 and the second corresponding image G12 into the extraction model 25A, and extracts a lower liver region from the second corresponding image G12.

In this way, by dividing the liver region into upper and lower regions, particularly for the lower region of the liver, there is no need to process the region on the right side of the liver as compared with the case where the corresponding image G1 and the reduced liver image GS1 are used. Therefore, the amount of calculation performed by the extraction model 25A can be reduced, and as a result, extraction of the liver region can be performed at a higher speed.

Here, in the case of dividing the liver region, it is preferable to train the extraction model 25A using supervised training data in which the mode of division is variously changed. Accordingly, in a case where the liver region is divided, the robustness in the case where the extraction model 25A extracts the liver region from the corresponding image G1 can be improved.

In the above embodiment, the liver is used as the object included in the target image G0, but the object is not limited to the liver. In addition to the liver, the object can be any part of a human body such as a heart, lung, brain, and limbs.

Further, in the above embodiment, the CT image is used as the target image G0, but the present disclosure is not limited thereto. In addition to a three-dimensional image such as an MRI image, any image such as a radiation image acquired by simple imaging can be used as the target image G0.

Further, in the above embodiment, for example, as hardware structures of processing units that execute various kinds of processing, such as the information acquisition unit 21, the reduction unit 22, the first extraction unit 23, the second extraction unit 24, the third extraction unit 25, the learning unit 26, and the display control unit 27, various processors shown below can be used. As described above, the various processors include a programmable logic device (PLD) as a processor of which the circuit configuration can be changed after manufacture, such as a field programmable gate array (FPGA), a dedicated electrical circuit as a processor having a dedicated circuit configuration for executing specific processing such as an application specific integrated circuit (ASIC), and the like, in addition to the CPU as a general-purpose processor that functions as various processing units by executing software (programs).

One processing unit may be configured by one of the various processors, or may be configured by a combination of the same or different kinds of two or more processors (for example, a combination of a plurality of FPGAs or a combination of the CPU and the FPGA). In addition, a plurality of processing units may be configured by one processor.

As an example in which a plurality of processing units are configured by one processor, first, there is a form in which one processor is configured by a combination of one or more CPUs and software as typified by a computer, such as a client or a server, and this processor functions as a plurality of processing units. Second, there is a form in which a processor for realizing the function of the entire system including a plurality of processing units via one integrated circuit (IC) chip as typified by a system on chip (SoC) or the like is used. In this way, various processing units are configured by one or more of the above-described various processors as hardware structures.

Furthermore, as the hardware structure of the various processors, more specifically, an electrical circuit (circuitry) in which circuit elements such as semiconductor elements are combined can be used.

What is claimed is:

1. An image processing apparatus comprising at least one processor,
wherein the processor is configured to:
acquire a target image;
reduce the target image to derive a reduced image of the target image;
extract a first region from the reduced image to derive a reduced structure image including the first region by a first extraction model without rest of structures of the reduced image;
enlarge the reduced structure image to have a same resolution as the target image to derive an enlarged reduced structure image;
extract, from the target image, a corresponding image which correlates to the enlarged reduced structure image;
input at least one of the corresponding image or the enlarged reduced structure image into an input layer of a second extraction model which includes a plurality of processing layers and is a neural network constructed by machine-learning to generate an output of the input layer;
perform, by the plurality of processing layers, a convolution processing of the output of the input player to generate an input to an output layer of the neural network; and
output, from the output layer, an extracted image in which a second region is included, wherein the second region of the extracted image corresponds to the first region.

2. The image processing apparatus of claim 1, wherein the processor is configured to enlarge the reduced structure image to have the same resolution as the target image to derive the enlarged reduced structure image further comprising:
enlarge the reduced structure image to have a same size as the corresponding image to derive the enlarged reduced structure image.

3. The image processing apparatus of claim 1, wherein the second extraction model further includes an output layer which receives an output from the plurality of processing layers to generate the extracted image.

4. The image processing apparatus of claim 1, wherein the processor is configured to:
divide the first region of the reduced image into a plurality of regions so as to derive a first reduced structure image and a second reduced structure image;
derive a first corresponding image corresponding to the first reduced structure image and as second corresponding image corresponding to the second reduced structure image; and
extract a region corresponding to the first corresponding image and another region corresponding to the second corresponding image.

5. The image processing apparatus of claim 1, wherein second extraction model is the neural network constructed by machine-learning by training with supervised training data which includes a teacher-reduced liver image, a teacher-corresponding image, and a correct answer data.

6. The image processing apparatus of claim 5, wherein the teacher-reduced liver image is generated by extracting a target region from a reduced image of a medical image, and the teacher-corresponding image is obtained from extracting a region of the teacher-reduced liver image and from the correct answer data.

7. The image processing apparatus of claim 6, wherein the correct answer data is an image in which the target region is masked in the teacher-corresponding image.

8. The image processing apparatus of claim 1, wherein the input layer of a second extraction model has two channels for inputting the corresponding image and the enlarged reduced structure image respectively.

9. The image processing apparatus of claim 1, wherein the input layer of a second extraction model has only one channel as one of the corresponding image or the enlarged reduced structure image into the input layer and other one is input into a layer of the plurality of processing layers.

10. The image processing apparatus of claim 1, wherein the first region is a human organ in the reduced image and the second region is the same human organ in the extracted image.

11. An image processing method implemented by an image processing apparatus comprising a processor, the method comprising:
acquiring a target image;
reducing the target image to derive a reduced image of the target image;
extracting a first region from the reduced image to derive a reduced structure image including the first region by a first extraction model without rest of structures of the reduced image;
enlarging the reduced structure image to have a same resolution as the target image to derive an enlarged reduced structure image;
extracting, from the target image, a corresponding image which correlates to the enlarged reduced structure image;
inputting at least one of the corresponding image or the enlarged reduced structure image into an input layer of a second extraction model which includes a plurality of processing layers and is a neural network constructed by machine-learning to generate an output of the input layer;
performing, by the plurality of processing layers, a convolution processing of the output of the input player to generate an input to an output layer of the neural network; and
outputting, from the output layer, an extracted image in which a second region is included, wherein the second region of the extracted image corresponds to the first region.

12. A non-transitory storage medium storing a computer executable program to configure a processor of an image processing apparatus to implement functions comprising:
acquiring a target image;
reducing the target image to derive a reduced image of the target image;
extracting a first region from the reduced image to derive a reduced structure image including the first region by a first extraction model without rest of structures of the reduced image;
enlarging the reduced structure image to have a same resolution as the target image to derive an enlarged reduced structure image;
extracting, from the target image, a corresponding image which correlates to the enlarged reduced structure image;
inputting at least one of the corresponding image or the enlarged reduced structure image into an input layer of a second extraction model which includes a plurality of processing layers and is a neural network constructed by machine-learning to generate an output of the input layer;
performing, by the plurality of processing layers, a convolution processing of the output of the input player to generate an input to an output layer of the neural network; and
outputting, from the output layer, an extracted image in which a second region is included, wherein the second region of the extracted image corresponds to the first region.
